(19) United States
(12) Patent Application Publication
(10) Pub. No.: US 2008/0151434 A1
(43) Pub. Date: Jun. 26, 2008

(54) Low friction load/unload lift tab

(75) Inventors: Marsha A. Huha, Minneapolis, MN (US); Muichong Chai, Singapore (SG)

Correspondence Address: KINNEY & LANGE, P.A., 312 SOUTH 3RD STREET, THE KINNEY & LANGE BUILDING, MINNEAPOLIS, MN, 55415, US

(73) Assignee: Seagate Technology LLC, Scotts Valley, CA (US)

(21) Appl. No.: 11/644,042

(22) Filed: Dec. 22, 2006

(51) Int. Cl. G11B 5/54

(52) U.S. Cl. 360/254.8

(57) ABSTRACT

A transducing system includes a support assembly for supporting a transducer and a lift tab extending from the support assembly. The lift tab has a surface configured to lift the support assembly carrying the transducer up a load/unload ramp. The surface of the lift tab has a radius of curvature of less than 0.013 inches.

### BACKGROUND OF THE INVENTION

The present invention relates to a lift tab for loading and/or unloading a transducer between first (operating) and second (non-operating) positions, where the lift tab is configured to have low friction as it travels up and/or down a load/unload ramp.

In many devices that include supported transducers for reading and/or writing data, such as magnetic recording head assemblies for example, the support structure of the device is designed with a load/unload mechanism for transporting the supported transducer between operating and non-operating positions. For example, in a hard disc drive, a suspension assembly that supports the transducer is designed to include a lift tab that interacts with a load/unload ramp to move the transducer between an operating position on the disc and a non-operating position off of the disc.

One consideration in the design of a load/unload mechanism is to minimize the friction between the lift tab and the load/unload ramp, so that tribological wear, particle distribution, and power drain caused by friction are reduced. In disc drives for mobile handheld consumer products such as cameras and digital music players, the low mass of the devices limit battery weight (and capacity) so that power drains caused by friction in loading and unloading must be further reduced. Attempts have been made to reduce friction by using coatings on the surface of the lift tab and/or the load/unload ramp, treating the surface of the lift tab with a laser, or modifying the material of the lift tab. While these efforts have in some cases been able to reduce friction, they also add cost and/or complexity to the system. It would be beneficial to reduce friction associated with loading and unloading a transducer in a way that does not affect the cost and complexity of the transducing system.

### BRIEF SUMMARY OF THE INVENTION

The present invention provides a low friction lift tab for a transducing system that includes a support assembly for supporting a transducer. The lift tab extends from the support assembly, and has a surface configured to lift the support assembly carrying the transducer up a load/unload ramp. The surface of the lift tab has a radius of curvature of less than 0.013 inches.

### BRIEF DESCRIPTION OF THE DRAWINGS

FIG. 1 is a diagram illustrating a transducing system, in the form of a head gimbal assembly, utilizing a lift tab configured according to an embodiment of the present invention.

FIG. 2 is a detailed, bottom perspective view of a lift tab according to an embodiment of the present invention.

FIG. 3 is a detailed view illustrating the radius of the bottom surface of the lift tab according to an embodiment of the present invention.

FIG. 4A is a graph illustrating the friction-torque associated with the loading of a transducer in a system employing a lift tab having a radius of curvature of 0.027 inches.

FIG. 4B is a graph illustrating the friction-torque associated with the unloading of a transducer in a system employing a lift tab having a radius of curvature of 0.027 inches.

FIG. 4C is a graph illustrating the friction-torque associated with the loading of a transducer in a system employing a lift tab having a radius of curvature of 0.009 inches.

FIG. 4D is a graph illustrating the friction-torque associated with the unloading of a transducer in a system employing a lift tab having a radius of curvature of 0.009 inches.

### DETAILED DESCRIPTION

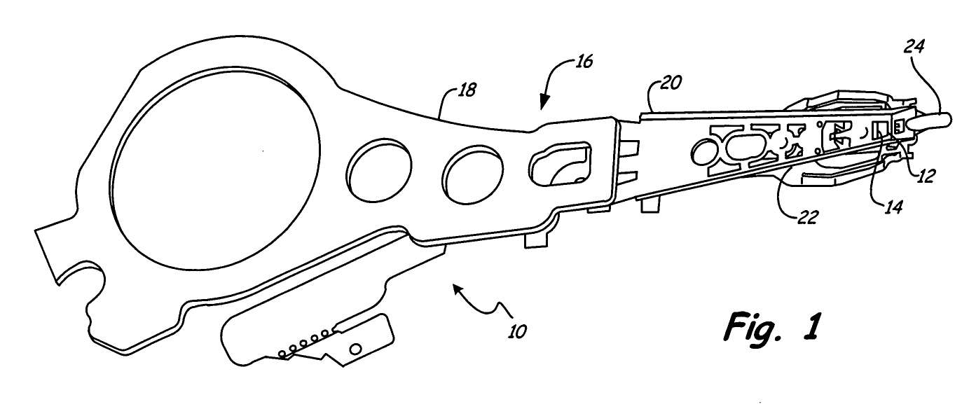

FIG. 1 is a diagram illustrating transducing system 10, in the form of a head gimbal assembly, for supporting one or more transducers 12 carried by a slider 14 with a support structure 16. In the exemplary system shown in FIG. 1, support structure 16 includes actuator arm 18 and load arm 20, along with a gimbal assembly, that provide physical support for slider 14 carrying transducer(s) 12, and flex circuit 22 is configured to make electrical connection with transducer(s) 12. Transducing system 10 may be provided as part of a hard disc drive (in which slider 14 is supported adjacent to a data-carrying disc medium (not shown)), or as part of another system in which a supported transducer is used.

Transducing system 10 also includes lift tab 24. Lift tab 24 is located at the distal end of support structure 16 to engage a load/unload ramp (not shown) that transports transducer 12 from a first (operating) position to a second (non-operating) position. For example, in a hard disc drive, lift tab 24 interacts with the load/unload ramp to move transducer 12 between an operating position on the disc and a non-operating position off of the disc.

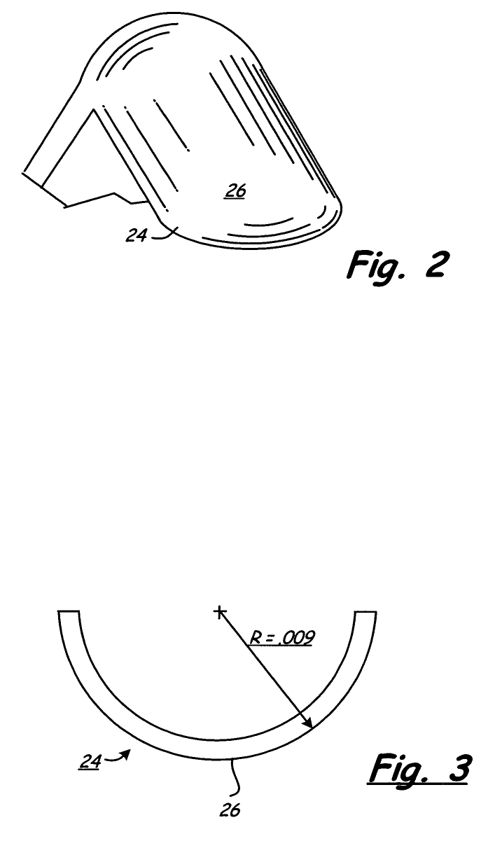

Systems such as transducing system 10 are known in the art, except that lift tab 24 of transducing system 10 is configured in accordance with the present invention to reduce the friction between lift tab 24 and a load/unload ramp as transducer 12 is transported between first and second positions. A specific description of lift tab 24 is provided below with respect to FIGS. 2 and 3.

FIG. 2 is a detailed, bottom perspective view of lift tab 24. Bottom surface 26 of lift tab 24 is configured with a radius of curvature of less than 0.013 inches. This is a substantially smaller radius of curvature than is employed in existing transducer systems. Bottom surface 26 of lift tab 24 interacts with a load/unload ramp to guide the support structure of the transducing system from a first (operating) position to a second (non-operating) position in an unload procedure, and from the second (non-operating) position to the first (operating) position in a load procedure. The configuration of bottom surface 26 with a radius of curvature of less than 0.013 inches results in a reduction of friction between lift tab 24 and the load/unload ramp during loading and unloading procedures, which provides a number of potential benefits.

FIG. 3 is a detailed view illustrating the radius of bottom surface 26 of lift tab 24 according to an embodiment of the present invention. Specifically, the radius of bottom surface 26 of lift tab 24 shown in the embodiment of FIG. 3 is about 0.009 inches.

### EXAMPLES

Various designs of lift tab 24 were empirically tested to determine the effect of the radius of lift tab 24 on the maximum friction force up a load/unload ramp in a disc drive. Comparative Example A employed a lift tab with a radius of 0.027 inches. Comparative Example B employed a lift tab with a radius of 0.018 inches. Example 1 employed a lift tab with a radius of 0.009 inches. The maximum friction forces generated as the lift tabs traveled up a load/unload ramp were as shown below in Table 1.

TABLE 1

| | MAXIMUM | |
|---|---|---|
| | FRICTION | STANDARD |
| | FORCE | DEVIATION |
| Comp. Ex. A (0.027 in.) | 0.18 grams force | 0.05 |
| Comp. Ex. B (0.018 in.) | 0.21 grams force | 0.06 |
| Example 1 (0.009 in.) | 0.10 grams force | 0.02 |

As can be seen from the data in FIG. 1, a reduction in the radius of the lift tab from 0.027 inches (Comparative Example A) to 0.018 inches (Comparative Example B) did not result in a reduction in the maximum friction force generated as the lift tab traveled up the load/unload ramp. However, a further reduction in the radius of the lift tab to 0.009 inches (Example 1) unexpectedly caused the maximum friction force to be reduced significantly.

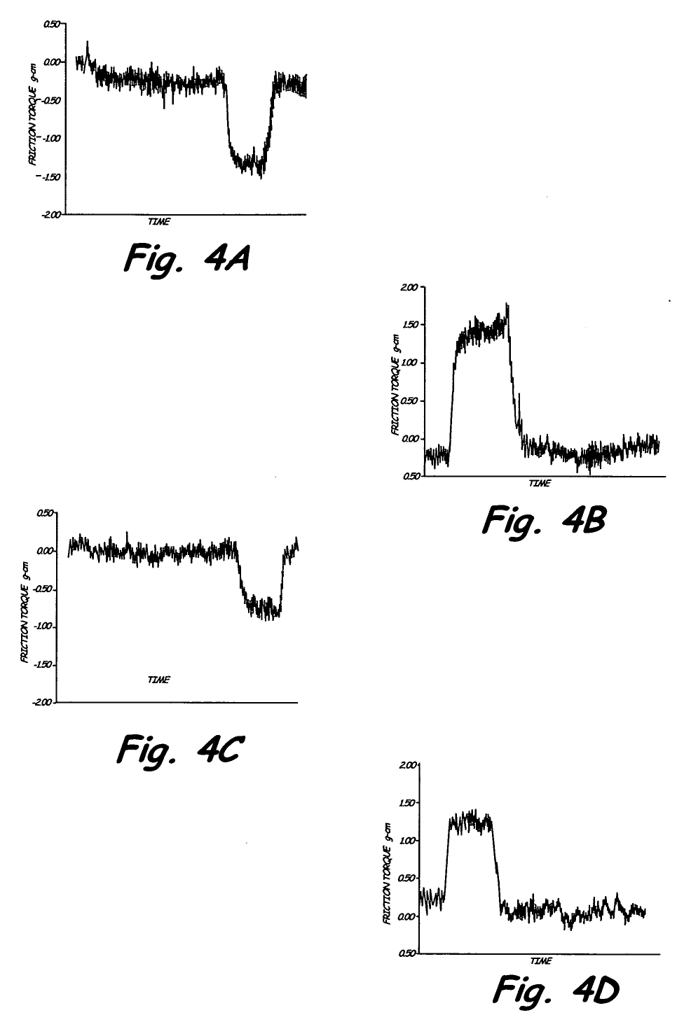

FIGS. 4A and 4B are graphs illustrating the friction-torque associated with the loading and unloading, respectively, of a transducer in a system employing a lift tab having a radius of curvature of 0.027 inches. FIGS. 4C and 4D are graphs illustrating the friction-torque associated with the loading and unloading, respectively, of a transducer in a system employing a lift tab having a radius of curvature of 0.009 inches, according to an embodiment of the present invention. As can be seen by comparing FIGS. 4A and 4C, the system having a lift tab with a 0.009 inch radius of curvature experienced substantially less friction in the loading procedure than the system having a lift tab with a 0.027 inch radius of curvature. Also, as can be seen by comparing FIGS. 4B and 4D, the system having a lift tab with a 0.009 inch radius of curvature experienced substantially less friction in the unloading procedure than the system having a lift tab with a 0.027 inch radius of curvature.

Although the present invention has been described with reference to preferred embodiments, workers skilled in the art will recognize that changes may be made in form and detail without departing from the spirit and scope of the invention.

1. A transducing system comprising:
a support assembly for supporting a transducer; and
a lift tab extending from the support assembly, the lift tab having a surface configured to lift the support assembly carrying the transducer up a load/unload ramp, the surface having a radius of curvature of less than 0.013 inches.

2. The transducing system of claim 1, wherein the surface has a radius of curvature of 0.009 inches.

3. The transducing system of claim 1, wherein the lift tab exhibits a maximum friction with the load/unload ramp of no greater than about 0.10 grams force during an unload operation in which the lift tab carries the support assembly up the load/unload ramp.

4. The transducing system of claim 1, wherein the transducer is carried by a slider and the support assembly comprises an actuator arm, a load arm and a gimbal assembly supporting the slider.

5. The transducing system of claim 4, further comprising a flex circuit for electrical connection to the transducer.

6. A method of loading and/or unloading a transducer between an operating position and a non-operating position, the method comprising:
supporting the transducer with a support structure; and
loading and/or unloading the support structure by guiding a lift tab of the support structure against a load/unload ramp, the lift tab having a radius of curvature of less than 0.013 inches.

7. The method of claim 6, wherein the lift tab has a radius of curvature of 0.009 inches.

8. The method of claim 7, wherein unloading the support structure by guiding a lift tab of the support structure against the load/unload ramp exhibits a maximum friction with the load/unload ramp of no greater than about 0.10 grams force.

9. The method of claim 6, wherein supporting the transducer is performed by a slider carried by the support structure, and the support structure comprises an actuator arm, a load arm and a gimbal assembly.
